(19) United States
(12) Patent Application Publication
(10) Pub. No.: US 2023/0343099 A1
(43) Pub. Date: Oct. 26, 2023

(54) VIDEO CODING BASED ON FEATURE EXTRACTION AND PICTURE SYNTHESIS

(71) Applicant: GUANGDONG OPPO MOBILE TELECOMMUNICATIONS CORP., LTD., Dongguan (CN)

(72) Inventors: Marek DOMANSKI, Poznan (PL); Tomasz GRAJEK, Poznan (PL); Slawomir MACKOWIAK, Poznan (PL); Slawomir ROZEK, Poznan (PL); Olgierd STANKIEWICZ, Poznan (PL); Jakub STANKOWSKI, Poznan (PL)

(21) Appl. No.: 18/217,826

(22) Filed: Jul. 3, 2023

Related U.S. Application Data
(63) Continuation of application No. PCT/CN2021/072767, filed on Jan. 29, 2021.

(30) Foreign Application Priority Data
Jan. 4, 2021 (EP) 21461503.1

(51) Int. Cl. G06V 20/40; G06V 10/44

(52) U.S. Cl. CPC G06V 20/46; G06V 10/449

(57) ABSTRACT

Computer-implemented methods, computer-readable media and devices for encoding video data using picture synthesis from features are provided. A computer-implemented method of encoding video data includes extracting features from a picture in a video; obtaining a predicted value of one or more regions in the picture by applying generative picture synthesis onto the features; obtaining a residual value of the one or more regions in the picture based on an original value of the one or more regions in the picture and the predicted picture; and encoding the residual value and the extracted features. Disclosed herein are also computer-implemented methods, computer-readable media and devices for decoding video data using picture synthesis from features.

### CROSS-REFERENCE TO RELATED APPLICATION

This is a continuation of International Patent Application No. PCT/CN2021/072767, filed on Jan. 19, 2021, which claims the benefit of priority to European patent application No. 21461503.1, filed on Jan. 4, 2021, both of which are hereby incorporated by reference in their entirety.

### BACKGROUND

Video compression is used in order to reduce the storage requirements of a video without substantially reducing the video quality so that the compressed video may be consumed by a human user. However, video is nowadays not only looked at by human beings. Fueled by the recent advances in machine learning along with the abundance of sensors, video data can successfully be analysed by machines, such as a self-driving vehicles, robots that autonomously move in an environment to complete a tasks, video surveillance and machines in the context of smart cities (e.g. traffic monitoring, density detection and prediction, traffic flow prediction). This led to the introduction of Video Coding for Machines (VCM) as described in document ISO/IEC JTC 1/SC 29/WG 2 N18 “Use cases and requirements for Video Coding for Machines”. MPEG-VCM aims to define a bitstream from compressing video or features extracted from video that is efficient in terms of bitrate/size and can be used by a network of machines after decompression to perform multiple tasks without significantly degrading task performance. The decoded video or feature can be used for machine consumption or hybrid machine and human consumption. In order to be able to analyse picture or video data, a machine must rely on features that have been extracted from the picture or video. The machines should also be able to exchange the visual data as well as the feature data, e.g. in order to be able to collaborate, so that such a standardization is needed to ensure interoperability between machines.

Modern metadata representation standards, including visual features, such as MPEG-7 (ISO/IEC 15938), offer the possibility to encode a description of the content. To be precise, MPEG-7 is not a standard that deals with the actual encoding of moving pictures and audio. MPEG-7 is a multimedia content description standard which is intended to provide complementary functionality of previous MPEG standards by representing information (description) about the content. The description of content is associated with the content itself, to allow fast and efficient searching for material that is of interest to the user. MPEG-7 requires that the description is separate from the audiovisual content.

However, when the video is compressed, the original video is compressed and the extracted features are separately compressed leading to a high demand of bandwidth. Generally image/video and feature(-s) are treated as a standalone tasks with completely different goals. So, it is the most straightforward approach to keep them separately. As always in the field of video compression technology, it would be desirable to have an encoding/decoding scheme that allows to further increase the compression rate and thereby reduce the transmission time of picture/video data.

### SUMMARY

The invention relates to the technical field of video coding and more particularly to video coding based on feature extraction and subsequent picture synthesis.

According to a first aspect, a method is provided of encoding video data. The method includes extracting features from a picture in a video. A predicted value of one or more regions in the picture is obtained by applying generative picture synthesis onto the features. A residual value of the one or more regions in the picture is obtained based on an original value of the one or more regions in the picture and the predicted value. The residual value and the extracted features are encoded.

According to a second aspect, a method is provided of decoding video data. The method includes decoding a bitstream to reconstruct features of a picture in a video. A predicted value of one or more regions in the picture is determined by applying generative picture synthesis onto the reconstructed features. The bitstream is decoded to reconstruct a residual value of the one or more regions in the picture, and a reconstructed value of the one or more regions in the picture is determined based on the predicted value and the residual value.

According to a third aspect, a computer-readable medium is provided which includes computer executable instructions stored thereon which when executed by a computing device cause the computing device to perform the method of encoding video data.

According to a fourth aspect, a computer-readable medium is provided which includes computer executable instructions stored thereon which when executed by a computing device cause the computing device to perform the method of decoding video data.

According to a fifth aspect, an encoder is provided. The encoder includes one or more processors; and a computer-readable medium comprising computer executable instructions stored thereon which when executed by the one or more processors cause the one or more processors to perform the method of encoding video data.

According to a sixth aspect, a decoder is provided. The decoder includes one or more processors; and a computer-readable medium comprising computer executable instructions stored thereon which when executed by the one or more processors cause the one or more processors to perform the method of decoding video data.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the scope of protection.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiment, in which the principles are utilized, and the accompanying drawings of which:

FIG. 1A is a considered scenario and shows a block diagram that illustrates a straightforward way of encoding visual data of a picture and features that have been extracted from the picture in a picture data encoder and a subsequent decoding of the encoded picture data in a picture data decoder.

FIG. 1B is a considered scenario and shows a block diagram that illustrates a straightforward way of encoding visual data of a video and features that have been extracted from the video in a video data encoder and subsequent decoding of the encoded video data in a video data decoder.

FIG. 2A shows in detail a block diagram of a picture data encoder according to embodiments of the invention.

FIG. 2B shows in detail a block diagram of a picture data decoder according to embodiments of the invention.

FIG. 3A shows in detail a block diagram of a video data encoder encoding a video according to embodiments of the invention.

FIG. 3B shows in detail a block diagram of a video data decoder according to embodiments of the invention.

FIG. 4A depicts a flow diagram which shows in detail steps of a method of encoding picture data according to embodiments of the invention.

FIG. 4B depicts a flow diagram which shows in details steps of a method of decoding picture data according to embodiments of the invention.

FIG. 5A depicts a flow diagram which shows in detail steps of a method of encoding a video data according to embodiments of the invention.

FIG. 5B depicts a flow diagram which shows in details steps of a method of decoding video data according to embodiments of the invention.

FIG. 6 is a block diagram that illustrates a computer device as well as a computer-readable medium upon which any of the embodiments described herein may be implemented.

The drawings depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

Efforts have been made to describe and claim the invention with regard to picture data as well as video data throughout the description, the drawing and the claims. Should some aspects of the invention only be described with regard to picture data or video data, it is emphasized that the invention in its entirety and all its aspect is equally applicable to both picture data and video data. Moreover, the term “video” encompasses the term “picture” since a video may comprise one or more pictures.

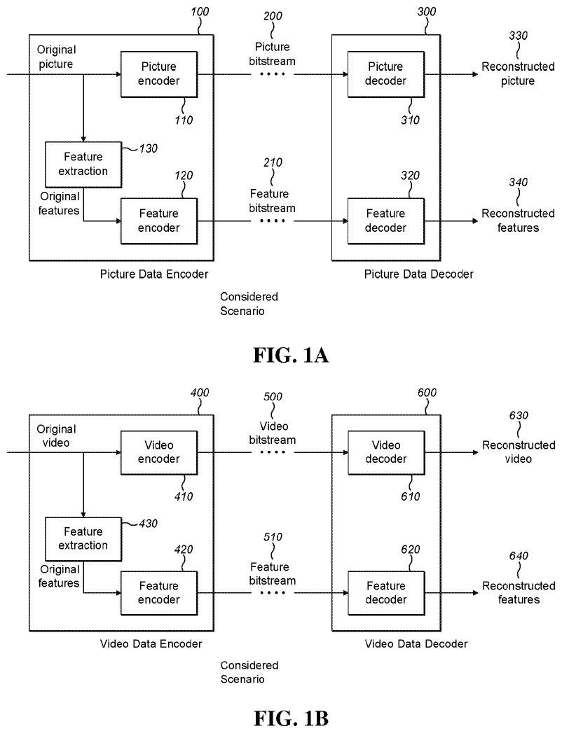

FIG. 1A shows a block diagram of encoding picture data (“Considered Scenario”). Before discussing the embodiment shown in FIG. 1 in more detail, a few items of the invention will be discussed.

The term “picture data” as used herein encompasses (i) visual picture data, i.e. the picture itself, which can encoded using a encoder, and (ii) also feature data that have been detected (extracted) in the picture. Similarly, the term “video data” as used herein comprises visual video data, i.e. the video itself, which can be encoded using a visual encoder, and also the features that have been detected (extracted) in the picture.

The term “feature” as used herein is data which is extracted from a picture/video and which may reflect some aspect of the picture/video such as content and/or properties of the picture/video. A feature may be a characteristic set of points that remain invariant even if the picture is e.g. scaled up or down, rotated, transformed using affine transformation, etc. Features may include properties like corners, edges, regions of interest, shapes, motions, ridges, etc. In general, the term “feature” as used herein is used as a generic term as usually used by picture/video descriptions described e.g. in the MPEG-7 standard.

A “picture encoder” is an encoder that is configured or optimized to efficiently encode visual data of a picture. A “video encoder” denotes an encoder that is configured or optimized to efficiently encode visual data of a video, such as MPEG-1, MPEG-2, MPEG-4, AVC (Advanced Video Coding, also referred to as H.264), VC-1, AVS (Audio Video Standard of China), HEVC (High Efficiency Video Coding, also referred to as H.265), VVC (Versatile Video Coding, also known as H.266) and AV1 (AOMedia Video 1). A “picture decoder” is a decoder that is configured or optimized to efficiently decode visual data of a picture. A “video decoder” denotes a decoder that is configured or optimized to efficiently decode visual data of a video, such as MPEG-1, MPEG-2, MPEG-4, AVC, HEVC, VVC and AV1.

A “feature encoder” is an encoder that is configured or optimized to efficiently encode feature data, such as MPEG-7, which is a standard that describes representations of metadata like video/image descriptors that can be also compressed in the binary form—otherwise e.g. they can be compressed as text. Binary coding of descriptions is a part of MPEG-7.

A “feature decoder” is a decoder that is configured or optimized to efficiently decode encoded features.

The term “video” may refer to a plurality of pictures but may also refer to only one picture. In that sense, the term “video” is broader than and encompasses the term “picture”.

The term “picture bitstream” is the output of a picture encoder and refers to a bitstream that encodes visual data of a picture (i.e. the picture itself). The term “video bitstream” is the output of a video encoder and refers to a bitstream that encodes visual data of a video (i.e. the video itself). A “feature bitstream” is the output of a feature encoder and refers to a bitstream that encodes features that have been extracted from an original picture.

Encoding

Some of the embodiments relate to a method of encoding video data. The method comprises extracting features from a picture in a video. A predicted value of one or more regions in the picture is obtained by applying generative picture synthesis onto the features. A residual value of the one or more regions in the picture is obtained based on an original value of one or more regions in the picture and the predicted picture. Then, the residual value and the extracted features are encoded. The residual value is obtained in such a way that the original value can be reproduced with possibly moderate or negligible difference between the original value and the reconstructed value. Although the method refers to video, it should be mentioned that it also covers picture processing because a video may consist of one picture only

In some of the embodiments, the original picture is an uncompressed picture. In other embodiments, the original picture is a compressed picture, such as a JPEG (JPEG 2000, JPEG XR, JPEG LS) or PNG picture, which is uncompressed before being encoded according to the method of as described above. In some of the embodiments, the original picture is obtained by means of a visual sensor as it is the case in many machine vision applications.

In some of the embodiments, the residual value is obtained by subtracting the predicted value from the original value which may be performed in a picture pre-encoder.

In some of the embodiments, the residual value is encoded using a video encoder and the extracted features are encoded using a feature encoder, wherein the video encoder is optimized to encode visual video data and the feature encoder is optimized to encode data relating to features.

In some of the embodiments, the method further includes transmitting the encoded residual value and the encoded extracted features in a picture bitstream and a feature bitstream, respectively.

In other embodiments, the method further includes multiplexing the encoded residual video and the encoded extracted features into a common bitstream and transmitting it. In yet other embodiments, the picture bitstream and the feature bitstream are transmitted independently with some common synchronization.

In some of the embodiments, the features are extracted using linear filtering or non-linear filtering. In a linear filter, each pixel is replaced by a linear combination of its neighbours. The linear combination is defined in form of a matrix, called “convolution kernel”, which is moved over the pixels of the picture. Linear edge filters include a Sobel, Prewitt, Roberts or Laplacian filter.

In some of the embodiments, the features are extracted using, for example, one of the following methods: Harris Corner Detection, Shi-Tomasi Corner Detector, Scale-Invariant Feature Transform (SIFT), Speeded-Up Robust Features (SURF), Features from Accelerated Segment Test (FAST), Binary Robust Independent Elementary Features (BRIEF) and Oriented Fast and Rotated BRIEF (ORB).

Many approaches have been suggested by traditional machine vision in order to detect/extract features from pictures. In some of the embodiments, a Harris Corner Detection is used which uses a Gaussian window function to detect corners. In other embodiments, a Shi-Tomasi Corner Detector is used which is a further development of the Harris Corner Detection in which the scoring function has been modified in order to achieve a better corner detection technique. In some of the embodiments, features are extracted using SIFT (Scale-Invariant Feature Transform) which is a scale invariant technique unlike the previous two. In some of the embodiments, the features are extracted using SURF (Speeded-Up Robust Features) which is a faster version of the SIFT. In yet other embodiments, FAST (Features from Accelerated Segment Test) is employed which is a faster corner detection technique than SURF.

In some of the embodiments, the features are extracted using a neural network. In some of these embodiments, the neural network is a convolutional neural network (CNN) which has the ability to extract complex features that express the picture in much more detail, learn the specific features and is more efficient. A few approaches include SuperPoint: Self-Supervise Interest Point Detection and Description, D2-Net: A Trainable CNN for Joint Description and Detection of Local Features, LF-Net: Learning Local Features from Images, Image Feature Matching Based on Deep Learning, Deep Graphical Feature Learning for the Feature Matching Problem. An overview of traditional and deep learning techniques for feature extraction can be found in the article “Image Feature Extraction: Traditional and Deep Learning Techniques” (https://towardsdatascience.com/image-feature-extraction-traditional-and-deep-learning-techniques-ccc059195d04).

In some of the embodiments, the features are extracted based on CDVS or CDVA. In particular, application of CDVS to feature representation and coding is very appropriate within the present invention. CDVS (Compact Descriptors for Visual Search) is part of the MPEG-7 standard and is an effective scheme for creating a compact representation of the pictures for visual search. CDVS is defined as an international ISO standard—ISO/IEC 15938. The features may be used in order to predict some picture/video content, i.e. the generative picture/video may be synthesized as low-quality picture or video version. For video, CDVA is an option as video feature description/compression method.

In some of the embodiments, the generative picture synthesis is based on a generative adversarial neural network. Generative Adversarial Networks (GANs for short) were introduced in 2014 by Ian J. Goodfellow and co-authors in the article “Generative Adversarial Nets” (Goodfellow, Ian; Pouget-Abadie, Jean; Mirza, Mehdi; Xu, Bing; Warde-Farley, David; Ozair, Sherjil; Courville, Aaron; Bengio, Yoshua (2014). “Generative Adversarial Networks”; Proceedings of the International Conference on Neural Information Processing Systems (NIPS 2014). pp. 2672-2680). Generative Adversarial Networks belong to a set of generative models which means that they are able to produce/to generate new content, e.g. picture or video content. A generative adversarial network comprises a generator and a discriminator which are both neural networks. The generator output is connected directly to the discriminator input. Through backpropagation, the discriminator's classification provides a signal that the generator uses to update its weights.

In some of the embodiments, the original picture is a monochromatic picture while in other embodiments, the original picture is a color picture. An example of how to generate pictures from features is disclosed, for example, in the article “Privacy Leakage of SIFT Features via Deep Generative Model based Image Reconstruction” by Haiwei Wu and Jiantao Zhou, see https://arxiv.org/abs/2009.01030.

In some of the embodiments, the method is a method of encoding video data which is performed on a plurality of pictures representing an original video. In some of these embodiments, the original video is an uncompressed video. In some of the embodiments, the original video is a compressed video compliant for example with AVC, HEVC, VVC and AV1 which is uncompressed before being applied to the method of encoding picture data. In some of the embodiments, the video comprises only one picture and the method is method of encoding picture data.

Some of the embodiments related to a computer-readable medium comprising computer executable instructions stored thereon which when executed by a computing device cause the computing device to perform the encoding method as described above.

Some of the embodiments relate to an encoder. The encoder includes one or more processors; and a computer-readable medium comprising computer executable instructions stored thereon which when executed by the one or more processors cause the one or more processors to perform the encoding method as described above.

Decoding

Some of the embodiments relate to a method of decoding video data. The method includes decoding a bitstream to reconstruct features of a picture in a video. A predicted value of one or more regions in the picture is determined by applying generative picture synthesis onto the reconstructed features. The bitstream is decoded to reconstruct a residual value of the one or more regions in the picture, and a reconstructed value of the one or more regions in the picture is determined based on the predicted value and the residual value.

In some of the embodiments, the method further includes outputting the predicted value for a low quality picture, e.g. for the purposes of machine vision.

In some of the embodiments, determining the reconstructed value includes fusing the predicted value to the residual value. In some of the embodiments, determining the reconstructed value includes adding the predicted value to the residual value. In some of the embodiments, the video decoding and the fusing are performed in one functional block.

In some of the embodiments, the residual value and the features are received in a video bitstream and a feature bitstream, respectively. In other embodiments, the encoded residual value and the encoded features are received in a multiplexed bitstream which is de-multiplexed in order to obtain a video bitstream and a feature bitstream, respectively.

In some of the embodiments, the features are decoded using a feature decoder and the residual value is decoded using a video decoder.

In some of the embodiments, the video comprises only one picture.

Some of the embodiments relate to a computer-readable medium comprising computer-executable instructions stored thereon which when executed by one or more processors cause the one or more processors to perform the decoding method as described above.

Some of the embodiments relate to a decoder which includes one or more processors; and a computer-readable medium comprising computer executable instructions stored thereon which when executed by the one or more processors cause the one or more processors to perform the decoding method as described above.

The inventors have recognized that the encoding of visual data can profit from the encoding of feature data. Therefore, a key feature of the architecture is the application of the generative picture synthesis, i.e. pictures or video frames predicted from features. In other words, since features are encoded anyway (i.e. since the features are part of the visual data, they are encoded twice. In the visual data and separately as features) because they are needed for picture analysis, their encoding can be synergistically leveraged for the encoding of visual data such that a prediction error/residual value only has to be encoded for the visual data. In yet other words, the feature extraction combined with the generative picture synthesis based on the features form a feedback bridge which enables the efficient encoding of visual picture data. Moreover, the picture/video encoding and picture/video decoding are implemented as a two-phase processes consisting of pre-encoding and (proper) encoding, and decoding and picture/video fusion, respectively. Pre-encoding produces a picture/video that can be then encoded by a picture/video encoder in such a way that after fusion in a decoder the difference between reconstructed video and the original video will be possibly small by possible low total bitrate for video and features. In such a way, known encoders are applicable.

Returning now to FIG. 1A which shows a considered scenario of encoding picture data, transmitting it and subsequently decoding it again as shown in ISO/IEC JTC 1/SC 29/WG 2 N18 “Use cases and requirements for Video Coding for Machines”, see https://isotc.iso.org/livelink/livelink/open/jtc1sc29wg2. An original picture is received at a picture data encoder 100 that has two encoding components, a picture encoder 110 and a feature encoder 120. The picture encoder 110 is configured to encode (compress) the visual data of the picture, i.e. the picture itself, while the feature encoder 120 is configured to encode features that have been detected in the picture. The feature detection/extraction is performed in a feature extraction component 130 that is configured to detect features in the original picture using known feature extraction techniques. The encoded picture data is transmitted via a picture bitstream 200 to a picture data decoder 300 which has a picture decoder 310 to decode the picture in order to obtain a reconstructed picture 330. The encoded features are transmitted in a feature bitstream 210 and are decoded by a feature decoder 320 to obtain reconstructed features 340. The general scheme described in FIG. 1A is a considered scenario that is inefficient from the point of view of the bitrate needed to transmit both picture and features. It should be noted that the encoding of the picture and the features are completely independent of each other and the encoding of the picture does not make use of the encoding of the features.

FIG. 1B which shows a straightforward way of encoding video data, transmitting it and decoding it again. An original video is received at a video data encoder 400 that has two encoding components, a video encoder 410 and a feature encoder 420. The video encoder 410 is configured to encode (compress) the visual data of the video, i.e. the video itself, while the feature encoder is configured to encode features that have been detected in the video. The feature detection/extraction is performed in a feature extraction component 430 that is configured to detect features in the pictures of the original video using known feature extraction techniques. The encoded video data is transmitted via a video bitstream 500 to a video data decoder 600 which has a video decoder 610 to decode the video data in order to obtain a reconstructed picture 630. The encoded features are transmitted in a feature bitstream 510 and are decoded by a feature decoder 620 to obtain reconstructed features 640. The general scheme described in FIG. 1B is a straightforward approach that is inefficient from the point of view of the bitrate needed to transmit both video data and features. It should be noted that the encoding of the video and the features are completely independent of each other and the encoding of the video does not make use of the encoding of the features.

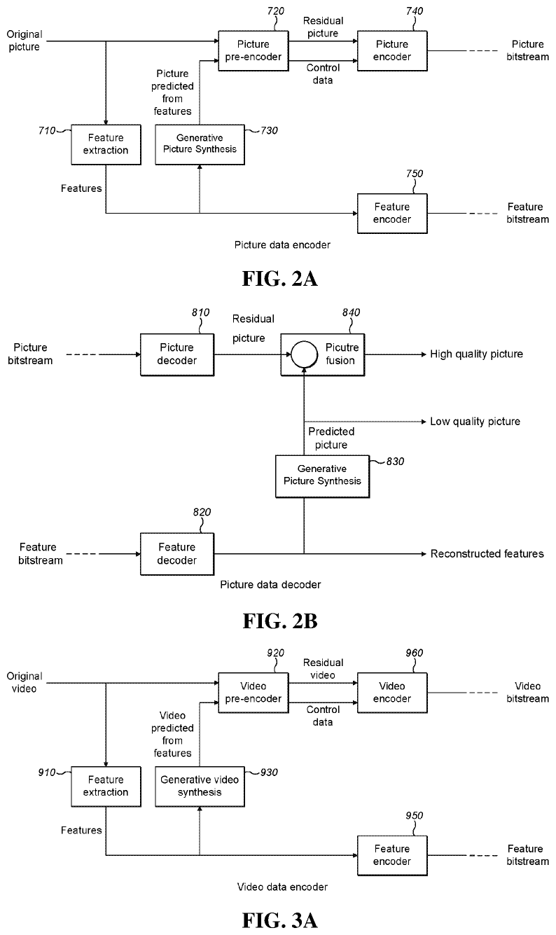

FIG. 2A shows a picture data encoder according to embodiments of the invention. An original picture is received at an input of a picture pre-encoder 720 and features are extracted at a feature extraction component 710 which may apply any feature extraction techniques that are known in the art. Once the features have been extracted, a generative picture synthesis 730 is applied to them. In some of the embodiments, the generative picture synthesis is a Generative Adversarial Neural Network (GAN) which is able to generate a picture (or a region/block thereof) that is predicted from the features.

In a GAN structure, there are two agents competing with each other: a generator and a discriminator. They may be designed using different networks (e.g. Convolutional Neural Networks (CNNs), Recurrent Neural Networks (RNNs), or just Regular Neural Networks (ANNs or RegularNets)). Since pictures are generated in the present invention, CNNs are better suited for the task. The generator will be asked to generate pictures without giving it any additional data. Simultaneously, the features are fetched to the discriminator and ask it to decide whether the pictures generated by the Generator are genuine or not. At first, the generator will generate pictures of low quality (distorted pictures) that will immediately be labeled as fake by the discriminator. After getting enough feedback from the discriminator, the generator will learn to trick the discriminator as a result of the decreased variation from the genuine pictures. Consequently, a generative model is obtained which can give realistic pictures that are predicted from the features.

The picture predicted from the features is subtracted from the picture data that is output, together with control data, by the picture pre-encoder 720 to obtain a picture prediction error which is also referred to as a residual picture which can then be efficiently encoded by a picture encoder 740 and transmitted in a picture bitstream. (It should be mentioned that in standards such as HEVC and VVC, the prediction is not defined/performed for an entire picture but for regions or blocks of a picture, as will be explained below.) For example, the picture pre-encoder 720 produces a residual picture in such a way that the edges of the objects are adopted to the large coding unit borders. In such a way the bitrate is reduced. The features which have been extracted in the feature extraction component 710 will be encoded by a feature encoder 750 which is optimized to compress features. The encoded features will be transmitted in form of a feature bitstream. In contrast to the approach of FIG. 1a, the inventors have recognized that extracted features can be used to encode the picture in order to obtain a higher compression rate. It should be mentioned that in contrast to other techniques there is no need for a decoder on the encoder side.

FIG. 2B shows a picture data decoder that is able to decode the picture data which have been encoded as shown in FIG. 2A. In other words, FIG. 2B mirrors or reverses the operations shown in FIG. 2A. A picture bitstream is received at the decoder and is input into a picture decoder 810 that is able to reverse the operation of the picture encoder 740. A bitstream of encoded features is also received and is input into a feature decoder 820 which is able to reconstruct the encoded features. A generative picture synthesis 830, for example in form of a GAN, is applied to the reconstructed features to obtain a predicted picture which can be output as a low quality picture or can be used for further processing. The picture decoder 810 decodes the picture bitstream to obtain a picture prediction error, which is also referred to as a residual picture, which is fused with the predicted picture in a picture fusion component 840. For example, the shape is reconstructed from a shape descriptor and color information is taken from the decoded picture. It should be noted that the picture decoder 810 and the picture fusion component 840 may be merged into one functional block. Outputting a low quality picture for machine vision as well as a high quality picture mainly destined for human beings as well as outputting the reconstructed features may be referred to as a “hybrid outputting approach”. This approach is useful where machines work with features only and visual information is useful for monitoring by humans.

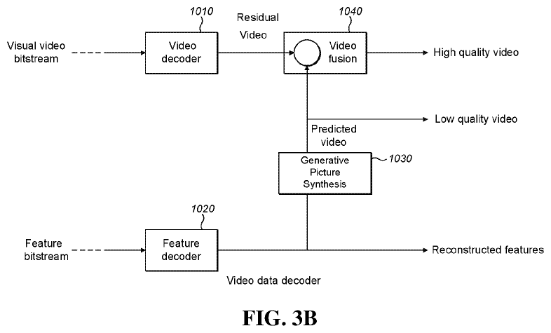

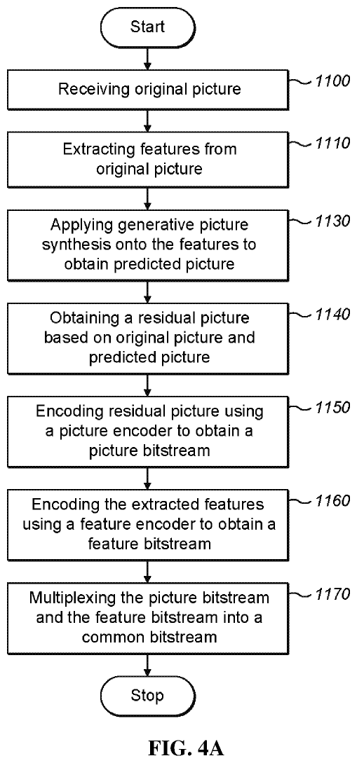

FIG. 3A shows a video data encoder according to embodiments of the invention. An original video is received at an input of the encoder and features are extracted from pictures of the video at a feature extraction component 910 which may apply any feature extraction techniques that are known in the art. Once the features have been extracted, a generative picture synthesis 930 is applied to regions/blocks of pictures in the video or the entire pictures in the video to obtain predicted values (relating to a region or block) or predicted entire pictures.

In some of the embodiments, the generative picture synthesis is a Generative Adversarial Neural Network (GAN) which is able to generate pictures, and finally a video, that is/are predicted from the features. In a GAN structure, there are two agents competing with each other: a generator and a discriminator. They may be designed using different networks (e.g. Convolutional Neural Networks (CNNs), Recurrent Neural Networks (RNNs), or just Regular Neural Networks (ANNs or RegularNets)). Since videos are generated in the present invention, CNNs are better suited for the task. Nevertheless very many techniques may be used here, not necessary based on Neural Networks. The generator will be asked to generate pictures without giving it any additional data. Simultaneously, the features are fetched to the discriminator and ask it to decide whether the pictures generated by the generator are genuine or not. At first, the generator will generate pictures of low quality that will immediately be labeled as fake by the discriminator. After getting enough feedback from the discriminator, the generator will learn to trick the discriminator as a result of the decreased variation from the genuine videos. Consequently, a good generative model is obtained which can give realistic videos that are predicted from the features.

In a video pre-encoder 920, the values predicted from the features are subtracted from the original video to obtain a residual video which can then be efficiently encoded by a video encoder 960 and transmitted in a video bitstream. The features which have been extracted in the feature extraction component 910 will be encoded by a feature encoder 950 which is optimized to compress feature data. The video pre-encoder 920 also sends control data to the video encoder 960 so that, for example, the video controller is controlled in such a way that it outputs either no motion vectors or the motion vectors are only the residuals to the motion information retrieved from motion descriptors. Therefore, the bitrate for the video bitstream can be reduced because less bits (or no bits are required from motion information). The encoded features will be transmitted in form of a feature bitstream. In contrast to the approach of FIG. 1b, the inventors have recognized that extracted features can be used to encode visual video data in order to obtain a higher compression rate.

FIG. 3b shows a video data decoder that is able to decode the video data which has been encoded as shown in FIG. 3A. In other words, FIG. 3b mirrors or reverses the operations shown in FIG. 3A. A video bitstream is received at the video data decoder and is input into a video decoder 1010 that is able to reverse the operation of the video encoder 960. A bitstream of encoded features is also received and is input into a feature decoder 1020 which is able to reconstruct the encoded features. A generative picture synthesis 1030, for example in form of a GAN, is applied to the reconstructed features to obtain a predicted video which can be output as a low quality video or can be used for further processing for purposes of machine vision. The video decoder 1010 decodes the video bitstream to obtain a video prediction error, which is also referred to as a residual video, which can be fused with the predicted video in a video fusion component 1040 to obtain a high quality video. It should be noted that the video decoder 1010 and the video fusion component 1040 may be merged into one functional block. Outputting a low quality video for machine vision as well as a high quality video mainly destined for human beings as well as outputting the reconstructed features may be referred to as a “hybrid outputting approach”.

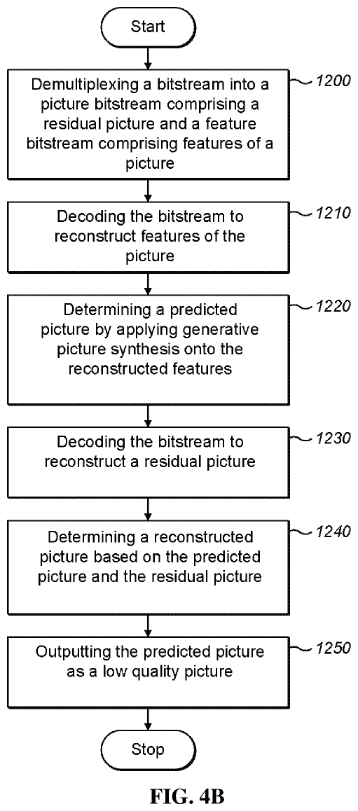

FIG. 4A shows a flow diagram for encoding picture data (comprising visual data as well as feature data). At 1100, an original picture is received. At 1110, features are extracted from the original picture using the feature extraction techniques that have been described in more detail above. For example, a neural network is applied to extract/detected the features in the original picture. At 1130, a generative picture synthesis is applied onto the extracted features to obtain a predicted picture. As discussed above, an examplary method of the generative picture synthesis is a Generative Adversarial Neural Network (GAN). At 1140, a residual picture, i.e. a picture prediction error, is obtained based on the original picture and the predicted picture. At 1150, the residual picture is encoded using a picture encoder to obtain a picture bitstream. A picture encoder is a device that is configured to efficiently encode visual data (in contrast to feature data) with the aim to reconstruct it for consumption of a human being. At 1160, the extracted features are encoded using a feature encoder, which is a device that is configured to efficiently encode feature data (in contrast to visual data), to obtain a feature bitstream. At 1170, which is an optional step, the picture bitstream and the feature bitstream are multiplexed into a common bitstream to be transmitted over a transmission medium. In other embodiments, the two bitstreams are transmitted separately.

FIG. 4B shows a flow diagram for decoding picture data that have been encoded according to the method as shown in FIG. 4A. In other words, FIG. 4B mirrors or reverses the operations shown in FIG. 4A. At 1200, which is an optional step, a bitstream that contains encoded visual data as well as a feature data is de-multiplexed into a picture bitstream that comprises an encoded residual picture and a feature bitstream comprising encoded features of a picture. At 1210, the bitstream is decoded to reconstruct features of the picture. At 1220, a predicted picture is determined by applying generative picture synthesis onto the reconstructed features. At 1230, the bitstream is decoded to reconstruct a residual picture. At 1240, a reconstructed picture is determined based on the predicted picture and the residual picture, e.g. using a picture fusion technique to obtain a high quality picture that may be destined to be consumed by a human being. At 1250, which is an optional step, the predicted picture is output as a low quality picture for example for the purposes of picture analysis in the field of machine vision. Of course, the reconstructed features can also be outputted, e.g. if needed by a machine.

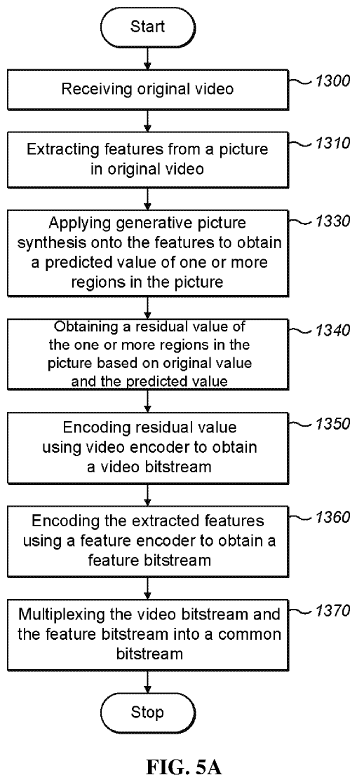

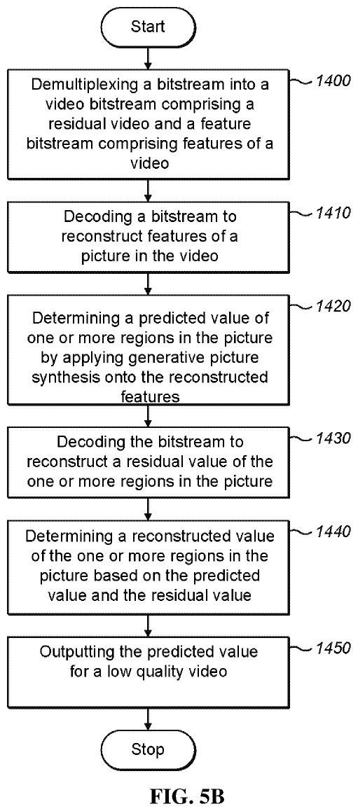

FIG. 5A shows a flow diagram for encoding video data (comprising visual data as well as feature data). At 1300, an original video is received. At 1310, features are extracted from a picture in the original video using the feature extraction techniques that have been described in more detail above. For example, a neural network is applied to extract/detected the features in the original video. At 1330, a generative picture synthesis is applied onto the extracted features to obtain a predicted value of one or more regions in the picture. As discussed above, an examplary method of the generative picture synthesis is a Generative Adversarial Neural Network (GAN). At 1340, a residual value of the one or more regions in the picture based on an original value of the one or more regions in the picture and the predicted value is obtained. At 1350, the residual video is encoded using a video encoder to obtain a video bitstream. A video encoder is a device that is configured to efficiently encode visual data (in contrast to feature data) with the aim to reconstruct it for consumption by a human being. At 1360, the extracted features are encoded using a feature encoder, which is a device that is configured to efficiently encode feature data (in contrast to visual data), to obtain a feature bitstream. At 1370, which is an optional step, the video bitstream and the feature bitstream are multiplexed into a common bitstream to be transmitted over a transmission medium. In other embodiments, the two bitstreams are transmitted separately.

FIG. 5B shows a flow diagram for decoding video data that has been encoded according to the method as shown in FIG. 5A. At 1400, which is an optional step, a bitstream that contains encoded visual data as well as a feature data is de-multiplexed into a video bitstream that comprises an encoded residual video and a feature bitstream comprising encoded features of a video. At 1410, the encoded residual video is decoded using a decoder to reconstruct features of a picture in the video. At 1420, a predicted value of one or more regions in the picture is determined by applying generative picture synthesis onto the reconstructed features. At 1430, the bitstream is decoded to reconstruct a residual value of the one or more regions in the picture. At 1440, a reconstructed value of the one or more regions in the picture is determined based on the predicted value and the residual value, e.g. using a picture fusion technique, to obtain a high quality video. The high quality video may be destined to be consumed by a human being. At 1450, which is an optional step, the predicted video is output as a low quality video to be viewed by a human being but, more importantly, for the purposes of video analysis in the field of machine vision. Of course, the reconstructed features can also be outputted, e.g. if needed by a machine.

Hardware Implementation

The techniques described herein are implemented by one or more special-purpose computing devices. The special-purpose computing devices may be hard-wired to perform the techniques, or may include circuitry or digital electronic devices such as one or more application-specific integrated circuits (ASICs) or field-programmable gate arrays (FPGAs) that are persistently programmed to perform the techniques, or may include one or more hardware processors programmed to perform the techniques pursuant to program instructions in firmware, memory, other storage, or a combination thereof. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

Computing device(s) are generally controlled and coordinated by operating system software, such as iOS, Android, Chrome OS, Windows XP, Windows Vista, Windows 7, Windows 8, Windows Server, Windows CE, Unix, Linux, SunOS, Solaris, iOS, Blackberry OS, VxWorks, or other compatible operating system. In other embodiments, the computing device may be controlled by a proprietary operating system. Conventional operating systems control and schedule computer processes for execution, perform memory management, provide file system, networking, I/O services, and provide a user interface functionality, such as a graphical user interface (“GUI”), among other things.

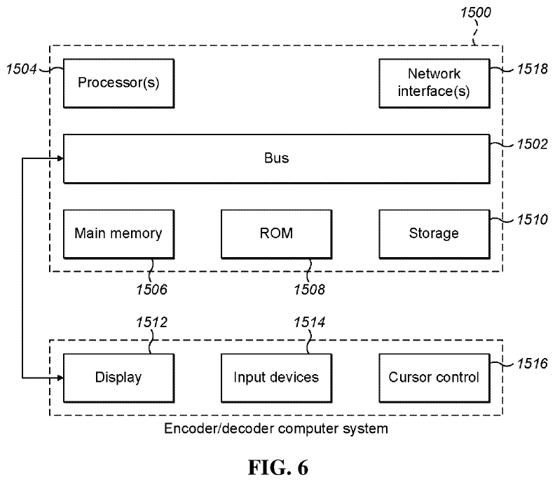

FIG. 6 is a block diagram that illustrates a encoder/decoder computer system 1500 upon which any of the embodiments, i.e. the picture data encoder/video data encoder as shown in FIGS. 2A and 3A and picture data decoder/video data decoder as shown in FIGS. 2B and 3B and the methods running on these devices as described herein may be implemented. The computer system 1500 includes a bus 1502 or other communication mechanism for communicating information, one or more hardware processors 1504 coupled with bus 1502 for processing information. Hardware processor(s) 1504 may be, for example, one or more general purpose microprocessors.

The computer system 1500 also includes a main memory 1506, such as a random access memory (RAM), cache and/or other dynamic storage devices, coupled to bus 1502 for storing information and instructions to be executed by processor 1504. Main memory 1506 also may be used for storing temporary variables or other intermediate information during execution of instructions to be executed by processor 1504. Such instructions, when stored in storage media accessible to processor 1504, render computer system 1500 into a special-purpose machine that is customized to perform the operation specified in the instructions.

The computer system 1500 further includes a read only memory (ROM) 1508 or other static storage device coupled to bus 1502 for storing static information and instructions for processor 1504. A storage device 1510, such as a magnetic disk, optical disk, or USB thumb drive (Flash drive), etc., is provided and coupled to bus 1502 for storing information and instructions.

The computer system 1500 may be coupled via bus 1502 to a display 1512, such as a LCD display (or touch screen) or other displays, for displaying information to a computer user. An input device 1514, including alphanumeric and other keys, is coupled to bus 1502 for communicating information and command selections to processor 1504. Another type of user input device is cursor control 616, such as mouse, a trackball, or cursor directions keys for communicating direction information and command selections to processor 1504 and for controlling cursor movement on display 1512. This input device typically has two degrees of freedom in two axes, a first axis (e.g., x) and a second axis (e.g., y), that allows the device to specify positions in a plane. In some embodiments, a same direction information and command selections as cursor control may be implemented via receiving touches on a touch screen without a cursor.

The computer system 1500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module” as used herein, refers to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM.

It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage.

The computer system 1500 may implement the techniques described herein using customized hard-wired logic, one or more ASIC or FPGAs, firmware and/or program logic which in combination with the computer system causes or programs computer system 1500 to be a special-purpose machine. According to one embodiment, the techniques herein are performed by computer system 1500 in response to processor(s) 1504 executing one or more sequences of one or more instructions contained in main memory 1506. Such instructions may be read into main memory 1506 from another storage medium, such as storage device 1510. Execution of the sequences of instructions contained in main memory 1506 causes processor(s) 1504 to perform the process steps described herein. In alternative embodiments, hard-wired circuitry may be used in place of or in combination with software instructions.

The term “non-transitory media” and similar terms, as used herein refers to any media that store data and/or instructions that cause a machine to operate in specific fashion. Such non-transitory media may comprise non-volatile media and/or volatile media. Non-volatile media includes, for example, optical or magnetic disks, such as storage device 1510. Volatile media includes dynamic memory, such as main memory 1506. Common forms of non-transitory media include, for example, a floppy disk, a flexible disk, hard disk, solid state drive, magnetic tape, or any other magnetic data storage medium, a CD-ROM, any other optical storage medium, any physical medium with patterns of holes, a RAM, a PROM, and EPROM, a FLASH-EPROM, NVRAM, any other memory chip or cartridge, and networked versions of a same.

Non-transitory media is distinct from but may be used in conjunction with transmission media. Transmission media participates in transferring information between non-transitory media. For example, transmission media includes coaxial cables, copper wire and fiber optics, including the wires that comprise bus 1502. Transmission media can also take the form of acoustic or light waves, such as those generated during radio-wave and infra-red data communications.

Various forms of media may be involves in carrying one or more sequences of one or more instructions to processor 1504 for execution. For example, the instructions can initially be carried on a magnetic disk or solid state drive of a remote computer. The remote computer may load the instructions into its dynamic memory and send the instructions over a telephone line using a modem. A modem local to computer system 1500 can receive the data on the telephone line and use an infra-red transmitter to convert the data to an infra-red signal. An infra-red detector can receive the data carried in the infra-red signal and appropriate circuitry can place the data on bus 1502. Bus 1502 carries the data to main memory 1506, from which processor 1504 retrieves and executes the instructions. The instructions received by main memory 1506 may optionally be stored on storage device 1510 either before or after execution by processor 1504.

The computer system 1500 also includes a communication interface 1518 coupled to bus 1502 via which encoded picture data or encoded video data may be received. Communication interface 1518 provides a two-way data communication coupling to one or more network links that are connected to one or more local networks. For example, communication interface 1518 may be an integrated services digital network (ISDN) card, cable modem, satellite modem, or a modem to provide a data communication connection to a corresponding type of telephone line. As another example, communication interface 1518 may be a local area network (LAN) card to provide a data communication connection to a compatible LAN (or WAN component to communicated with a WAN). Wireless links may also be implemented. In any such implementation, communication interface 1518 sends and receives electrical, electromagnetic or optical signal that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet”. Local network and Internet both use electrical, electromagnetic or optical signals that carry digital data streams. The signals through the various networks and the signals on network link and through communication interface 1518, which carry the digital data to and from computer system 1500, are example forms of transmission media.

The computer system 1500 can send messages and receive data, including program code, through the network(s), network link and communication interface 1518. In the Internet example, a server might transmit a requested code for an application program through the Internet, the ISP, the local network and the communication interface 1518. The received code may be executed by processor 1504 as it is received, and/or stored in storage device 1510, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combine in various ways. All possible combination and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can”, “could”, “might”, or “may” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in a way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modification may be made to the above-describe embodiments, the elements of which are to be understood as being among other acceptable examples. All such modifications and variations are intended to be included herein within the scope of this disclosure. The foregoing description details certain embodiments of the disclosure. It will be appreciated, however, that no matter how detailed the foregoing appears in text, the concept can be practiced in many ways. As is also stated above, it should be noted that the use of particular terminology when describing certain features or aspects of the disclosure should not be taken to imply that the terminology is being re-defined herein to be restricted to including any specific characteristics of the features or aspects of the disclosure with which that terminology is associated. The scope of the protection should therefore be construed in accordance with the appended claims and equivalents thereof.

1. A computer-implemented method of encoding video data, the method comprising
extracting features from a picture in a video;
obtaining a predicted value of one or more regions in the picture by applying generative picture synthesis onto the features;
obtaining a residual value of the one or more regions in the picture based on an original value of the one or more regions in the picture and the predicted value; and
encoding the residual value and the extracted features.

2. The computer-implemented method of claim 1, wherein the residual value is obtained by subtracting the predicted value from the original value.

3. The computer-implemented method of claim 1, wherein the residual value is encoded using a video encoder and the extracted features are encoded using a feature encoder, wherein the video encoder is optimized to encode visual video data and the feature encoder is optimized to encode feature data.

4. The computer-implemented method of claim 1, further comprising transmitting the encoded residual value and the encoded extracted features in a video bitstream and a feature bitstream, respectively.

5. The computer-implemented method of claim 1, further comprising multiplexing the encoded residual value and the encoded extracted features into a common bitstream and transmitting the common bitstream.

6. The computer-implemented method of claim 1, wherein the features are extracted using linear filtering or non-linear filtering.

7. The computer-implemented method of claim 1, wherein the features are extracted using a neural network.

8. The computer-implemented method of claim 7, wherein the neural network is a convolutional neural network.

9. The computer-implemented method of claim 1, wherein the generative picture synthesis is obtained with a generative adversarial neural network.

10. The computer-implemented method of claim 1, wherein the picture in the video is a monochromatic picture or a color picture.

11. The computer-implemented method of claim 1, wherein the video comprises only one picture.

12. A computer-implemented method of decoding video data, the method comprising:
decoding a bitstream to reconstruct features of a picture in a video;
determining a predicted value of one or more regions in the picture by applying generative picture synthesis onto the reconstructed features;
decoding the bitstream to reconstruct a residual value of the one or more regions in the picture, and
determining a reconstructed value of the one or more regions in the picture based on the predicted value and the residual value.

13. The computer-implemented method of claim 12 further comprising
outputting the predicted value for a low quality video.

14. The computer-implemented method of claim 12, wherein determining the reconstructed value comprises adding the predicted value to the residual value.

15. The computer-implemented method of claim 12, wherein the residual value and the features are received in a video bitstream and a feature bitstream, respectively.

16. The computer-implemented method of claim 12, wherein the encoded residual value and the encoded features are received in a multiplexed bitstream which is de-multiplexed in order to obtain a video bitstream and a feature bitstream, respectively.

17. The computer-implemented method of claim 12, wherein the features are decoded using a feature decoder and the residual value is decoded using a video decoder.

18. The method of claim 12, wherein the video comprises only one picture.

19. A decoder, comprising
one or more processors; and
a computer-readable medium comprising computer executable instructions stored thereon which when executed by the one or more processors cause the one or more processors to perform:
decoding a bitstream to reconstruct features of a picture in a video;
determining a predicted value of one or more regions in the picture by applying generative picture synthesis onto the reconstructed features;
decoding the bitstream to reconstruct a residual value of the one or more regions in the picture, and
determining a reconstructed value of the one or more regions in the picture based on the predicted value and the residual value.

20. The decoder of claim 19, wherein the one or more processors is further caused to perform:
outputting the predicted value for a low quality video.
